(19) United States
(12) Patent Application Publication
(10) Pub. No.: US 2024/0072606 A1
(43) Pub. Date: Feb. 29, 2024

(54) PROCESS, METHOD AND DESIGN OF A HYBRID TRANSAXLE BATTERY POWERED INDUSTRIAL OR POWER PLANT

(71) Applicant: Rogelio Timbol Serafica, Makati (PH)

(72) Inventor: Rogelio Timbol Serafica, Makati (PH)

(21) Appl. No.: 17/821,802

(22) Filed: Aug. 24, 2022

(51) Int. Cl. H02K 7/18; H02J 7/00

(52) U.S. Cl. CPC H02K 7/1823; H02J 7/0063

(57) ABSTRACT

A process, system, design and method of producing electricity or electrical energy from a series of transaxle prime mover whose output when combined together could move large alternators and generator used in power plants, industrial plants and large sea vessels. The method or process involves the transfer of kinetic/mechanical energies such as speed and torque thru a series of small motors using various types of gears and shafts as transaxles to move and operate a much larger motor generator or alternator. The method, process or system uses a rechargeable battery system to initiate and operate each individual transaxle component system and to induce an enhanced combined output from each motor to generate more torque to act as prime mover or prime movers. The embodiment generates clean and affordable electrical and mechanical energy output through the use of a battery-powered system.

### BACKGROUND OF THE INVENTION

Humanity's success during the 19th century's age of industrial revolution has sent the world a grim warning in the 20th century's 1952 London's lethal smog acid rain pollution that resulted in thousands of deaths. Today's global pollution not only threatened humanity but all living creatures on the planet far more serious effects of climate change resulting in destructive carbon emission and an uncontrolled pollution in the air, water and land have finally reached a massive scale that knows no boundaries. A united front of rich and poor countries have come to address this modern-day malaise; thus, new technologies are now on the forefront to correct what have been neglected before and to address the problem and act fast as to pre-empt the forthcoming disasters from rising sea levels, forest fires, heat waves, storms, droughts and floods modern mankind have not seen before. However, modern civilization should move together with the fast phase of new commercial and industrial needs with caution and with a renewed outlook towards more environmentally friendly technologies.

The attempt to re-engineer old technology such as electric power has gained a good start and momentum with the commercialization of renewable power system starting from electric vehicles which is an old technology, the introduction of renewable power systems such as solar, wind and storage battery systems have gained adherents in the right direction. The embodiment of this invention will contribute substantially to the lessening of the culprit carbon emission as a result of burning fossil fuel from internal combustion engines now acknowledged as great pollutants.

The embodiment process or system employs a redesigned gear system motor transaxle to boost and add more power to another much large generator utilized by industries and power plants. From the combined designed gear boxes in a motor transaxle attached to a main power generator, a consistent, sustainable duty power generating plant could produce an enhanced power and electricity powered by a complex rechargeable battery system. Unlike a transaxle used by electric vehicles, a modified transaxle motor of this invention is situated outside the housing of the axles and gears without differentials. Burning fossil fuels are totally eliminated to power prime movers to generate electricity. Power plants using the process system and method named as “Process, Method and Design of a Multiple Hybrid Battery Power Plant” design would bring in a clean, safe, affordable and easy to install and operate technology.

### BRIEF DESCRIPTION OF DRAWING

FIG. 1 shows the basic layout of the power plant.

FIG. 2 shows the motor transaxle basic design.

FIG. 3 shows the gear ratios and components.

FIG. 4 shows the different configuration and placements of transaxles hooked or linked up to the main generator with planetary differential gear.

FIG. 5 shows a direct drive of two or more motor.

### DETAILED DESCRIPTION OF THE INVENTION

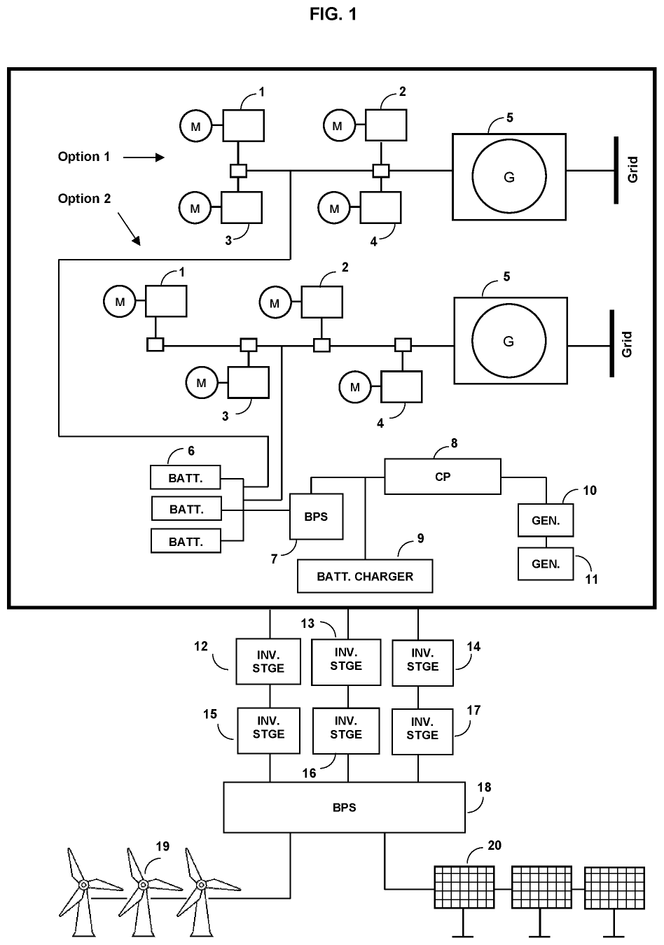

The embodiment of the invention and processes involve the enhancement of a combined modified transaxle motor 1, 2, 3, 4 to operate at least one-megawatt capacity but not limited to it or up to more than one hundred-megawatt generator 5. The use of several smaller capacity motors 1, 2, 3, 4 linked up in series through a system of gears known as modified transaxle composed of a combination, counter, ring, spur, planetary and helical gears in a gearbox. Each gear ratio functions as to transfer the speed and torque of smaller motor to the main generator 5 in order to initiate and sustainably rotate the rotor or stator of the main motor typically powered by a single prime mover with a greater force to provide the needed speed and torque to achieve the desired load either for electricity or a work load described in FIG. 1 with Options 1 and 2 power design configurations.

As presented in the embodiment, for a typical one-megawatt generator motor powered diesel-fed engine used as a prime mover, the basic requirement of the required force or horsepower should at least be greater than 745 horsepower (HP) at a speed of 1500 revolutions per minute (RPM) internal combustion engine. As a contrast, the embodiment or invention for presentation purposes of multiple motors uses at least four smaller motor 1, 2, 3, 4 with a capacity of 50 horsepower each. The combined output of the combined force, if no intervening combination of larger driven gear is introduced, would produce only 200 HP that may not be sufficient to operate and sustain the main motor's efficiency of 745 HP with the assumption that the torque requirement is 6369 nm at 1500 RPM. Basic torque needed formula and computation is as follows:

Torque formula for one-megawatt:
Power=Torque (newton meter)
(in watt) Angular velocity (in rads/s)
Torque=Power/Angular velocity at 1500 RMP, the angular velocity in rads/s is:
2π, 1500/60
=157 rads/s

Therefore:
Torque=1,000,000/157=6369 nm

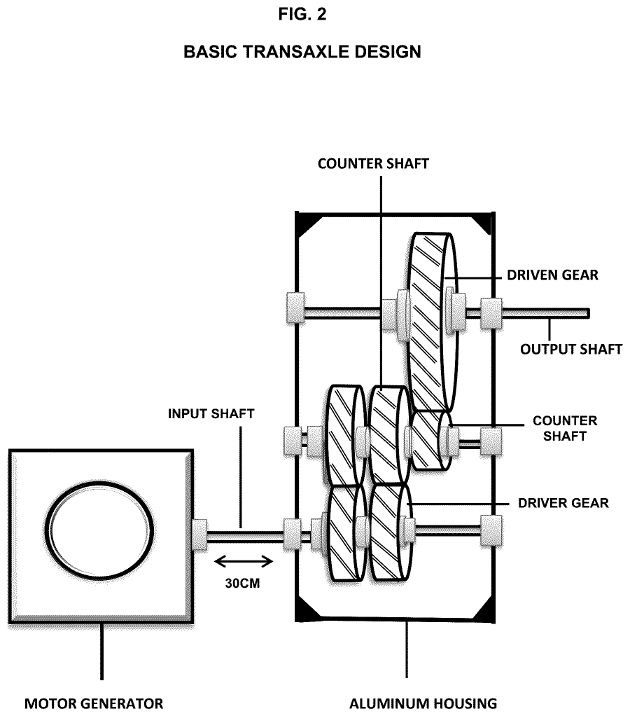

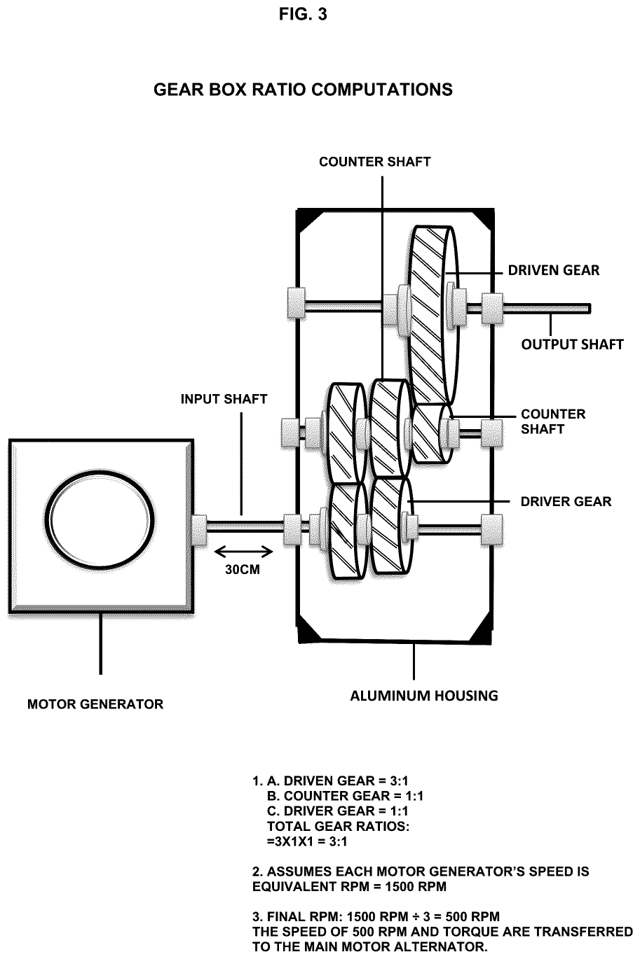

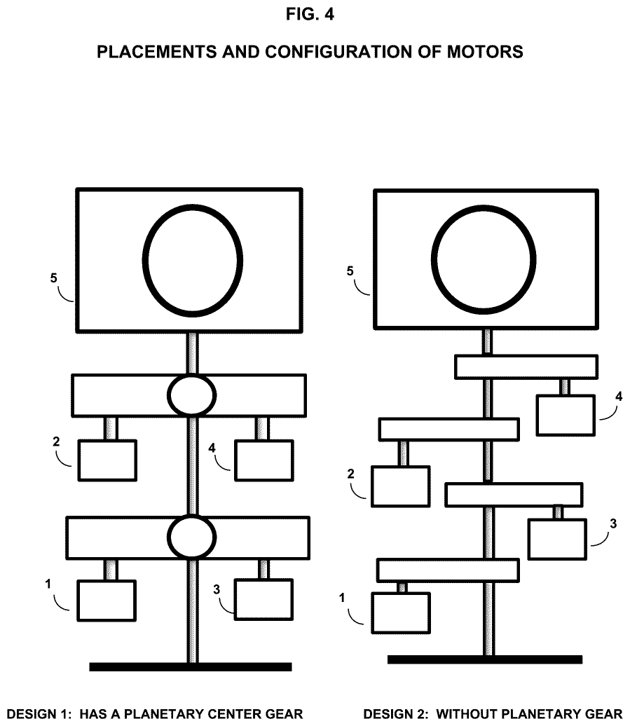

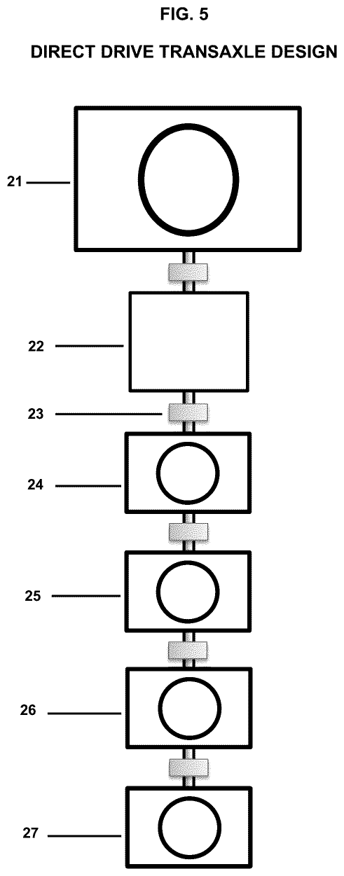

In order to enhance the required force to move the main motor, additional force and torque are generated by way of installing a bigger gear ratio at least 6:1 in FIG. 2, FIG. 3 and FIG. 4 the size of each individual smaller motor. The driver gear FIG. 2 and FIG. 3 from the smaller gear to the driven gear splined to the shaft leading to the main motor would provide the added torque but would slow down the angular 1500 RPM velocity coming from the smaller motor. The gear ratio of 6:1 splined to the shaft of the main motor from smaller ratio would provide additional torque power equivalent to at least 50 HP each smaller motor. The combined output of at least four transaxle motors 1, 2, 3, 4 at this juncture would be at least 200 HP enough to power the main generator which would only need 6369 nm amount of torque. Each smaller motor would be powered by rechargeable batteries 6 with backup power storage 7 linked to control panel 8 and inverter storages 12, 13, 14, 15, 16, 17 for a prolonged charging cycle or from a rechargeable battery pack 14, solar 15 or wind 16 power system. In FIG. 5 is a direct drive transaxle 22 configuration of a two or more splined 23 in a shaft motors 24, 25, 26, 27 to power a large generator 21 run by an all-battery system 9.

A multi-power source battery operating and charging system 9 is installed to power and to maintain consistency and assured of a sustained constant power supply. In the embodiment, a solar (pv) 19, a wind 20, battery power storage 18 self-charging stored motor 10, 11 are designed to supply continuously to the batteries and power storage system of the power plant or industrial facility.

1. A battery-powered power plant system comprising:
a) A plurality of motors (1, 2, 3, 4) operable to generate power;
b) A main generator (5) designed to receive power from said plurality of motors;
c) A system of gears, modified transaxle, including combination, counter, ring, spur, planetary, and helical gears, contained within a gearbox to transfer speed and torque from said plurality of motors to said main generator (5);
d) A rechargeable battery system (6) linked to each of said plurality of motors for supplying power to the generator (5);
e) A backup power storage (7) linked to said rechargeable battery system;
f) A control panel (8) for regulating and controlling power distribution;
g) An inverter system (12, 13, 14, 15, 16, 17) for managing and converting power;
h) A multi-power source battery operating and charging (9) system comprising solar (pv) power (19), wind power (20), a rechargeable storage battery and charger system (10, 11), and a battery power storage pack for supplying continuous power to said plurality of motors and said power storage system.
